(19) United States
(12) Patent Application Publication
(10) Pub. No.: US 2006/0115389 A1
(43) Pub. Date: Jun. 1, 2006

(54) Nanotechnological processing of catalytic surfaces

(76) Inventor: Robert Indech, Norcross, GA (US)

Correspondence Address: Wilson Daniel Swayze, Jr, 3804 Clearwater Ct, Plano, TX, 75025, US

(21) Appl. No.: 11/051,229

(22) Filed: Feb. 5, 2005

Related U.S. Application Data
(60) Provisional application No. 60/631,491, filed on Nov. 27, 2004.

(51) Int. Cl. B01D 53/34

(52) U.S. Cl. 422/168; 502/350

(57) ABSTRACT

Demanding chemical reactions typically require a catalyst of three-dimensional form rather than a flat surface. For ethane hydrogenolysis, one example, reaction rates increase by a factor of 20 by inserting into the reactants a 20-angstrom diameter micro-particle of surface nickel over a truncated octahedron base. Advanced nanotechnological processing techniques with ultrahigh cooling rates such as chill block melting will produce a locally atomically flat substrate. Placing this substrate in compressive stress and then depositing a catalytically active metal such as nickel or platinum on the substrate in a conventional atomic layer deposition system will create nano-scale surface ripples. The ripple wavelength and slope in two dimensions can be optimized to mimic the geometry of the bulk catalyst particles. This modified rippled surface built up over the substrate will have the enhanced catalytic properties of the nano-sphere catalyst, but will be firmly attached to the substrate, a marked advantage over insertion of catalytic particles into the reactant flow stream. This new surface will also allow far more efficient catalytic conversion of reactants flowing over the surface than simply a flat metal catalytic surface. For an automobile catalytic converter whose flow stream comprises gases with hydrocarbons requiring demanding catalytic reactions, such a modified surface will allow construction of a converter that is substantially smaller and less expensive than now exists. However, this technique is not confined to this particular application but is a general technique for enhancing the efficiency of demanding catalytic reactions utilizing fixed catalytic surfaces.

### PRIORITY

The present invention claims priority based on provisional application serial No. 60/631,491 filed on Nov. 30, 2004.

### FIELD OF THE INVENTION

The present invention details a general technique for enhancing the efficiency of demanding catalytic reactions utilizing fixed catalytic surfaces.

### BACKGROUND OF THE INVENTION

### Nature of Catalysis

In order to achieve a typical chemical reaction, the reactants must temporarily reach a higher energy state than baseline, while the energy state of the product so created is less than this higher energy state, but may be higher or lower than baseline. Typically, the energy difference between the reactants' initial state and this temporarily required energy peak, termed the activation energy, is provided by thermal energy. For a bulk reaction, only those reactants physically placed next to each other in a particular geometrical configuration, and possessing the minimum thermal activation energy, will proceed to final product. The presence of a catalyst in the reaction vessel will lower the activation energy, and thus increase the rate of reaction. This is diagrammatically illustrated in FIG. 1, which shows the general nature of a catalyst. FIG. 1 shows the catalyzed activation energy being lower than the uncatalyzed activation energy; consequently, this reaction will take place more quickly.

The overall rate of reaction is also directly dependent upon the surface area of the catalyst. If the catalyst were bound firmly to a surface, such as the surface of the reaction vessel, then one would wish to employ techniques to maximize the reactant-catalyst surface area. These techniques include the creation of catalyst coated micro-pores in the catalytic surface. A surface bound catalyst has the advantage of little loss of catalyst as the final product is removed from the reaction vessel, but the disadvantage that the reactants must flow over the surface, with a minimum flow boundary layer, so as to insure that the reaction is not diffusion limited. In an alternative configuration, the catalyst coats the surface of micro particles, which are then inserted into the reaction vessel. The micro catalytic particle approach allows greater variation in the morphology of the catalytic surface. However, it is often necessary to physically separate the catalyst particles from the product in order to reutilize the same catalyst to continue the reaction. There is also an intermediate state catalysis wherein the micro particles of catalyst are themselves interlaced with pores.

An example of coating the reaction vessel with catalyst would be the platinum based catalytic converter used in automobiles for purification of exhaust gases. In this configuration, no further manipulative processing is needed other than the flow of the reactants over the fixed catalytic surface. Current methods of surface preparation yield a surface that is atomically uneven and rough. This type of catalyst construction would be most useful in facile (structure-insensitive) reactions, where the reaction rate is not affected by the structure of the metal surface atoms. An example of a facile reaction would be ethylene hydrogenation.

Alternatively, an example of micro particle catalysis is the use of nickel crystallites for ethane hydrogenolysis. This type of catalyst construction would be most useful in demanding (structure-sensitive) reactions, where the reaction rate is affected by the ensemble structure of the metal atoms.

The majority of catalysts currently in use are based on pure metals such as nickel, gold, platinum or palladium, and upon metallic oxides. The general nature of catalysis is for the catalyst to present an outer electron shell configuration of the ensemble of atoms comprising the catalyst which is geometrically arranged in such a way that the reactants will find this a lower energy surface upon which to proceed to final product. Further, outer shell electrons of the catalyst may participate in bound intermediate products of the reaction, as long as the catalyst itself remains unchanged after the reaction goes to completion. To better understand the geometrical difference between a facile and a demanding reaction consider the linear configuration of ethylene, as shown in FIG. 2, where the hydrogen atoms are basically planar, and the protruding configuration of ethane, as shown in FIG. 3, where the hydrogen atoms are attached in 3-dimensional space at an angle of 109.6 degrees with respect to the carbon-carbon single bond. FIG. 2a shows the σ bond framework, FIG. 2b shows the formation of the π bond by the overlap of the half filled 2-P orbital, and FIG. 2c shows a hybridization and binding scheme.

It is known that the reaction rate of the demanding reaction ethane hydrogenolysis is highly dependent on the relative crystallize size of the nickel supported catalyst, reaching a peak reaction rate for crystallites of approximately 20 angstroms in diameter, and subsiding for crystallites of greater and lesser diameters. FIG. 4 shows the size dependency by showing Nickel Catalyst Size vs. Activity in Ethane Hydrogenolysis. FIG. 4 shows the calculated activities for a hypothetical supported nickel catalyst consisting of regular polyhedra fully comprised of (100) and (111) facets based on single Crystal data. In FIG. 4, the value R represents the ratio of (100) surface area to (111) surface area plotted against particle size (taken from Carter et al.).

The average nickel-to-nickel bond length is 2.54 angstroms. For a crystallite of 20 angstrom diameter, corresponding to a circumference of 63 angstroms, the perfect nickel sphere would have approximately 24-25 nickel atoms in a row along the circumference.

### Geometry of Certain Catalytic Crystallites

The field of nanotechnology involves structures in which at least one of their dimensions is less than 100 nanometers. Throughout this discussion of catalysts, it is considered that the catalyst, either as a particle or a modified surface is within this nanotechnology size range. There is an optimal dimension for the crystallite-based catalyst for a particular demanding catalytic reaction that will maximize the reaction rate. Consider the structure of the nickel catalyst that is placed upon a sodalite core, as in FIG. 4. FIG. 5 illustrates that sodalite is a subset of the zeolites, which are aluminosilicate framework structures built from corner sharing tetrahedral bases. However, the zeolite framework, unlike pure silicon oxide, contains large voids or pores. Sodalite is composed of hexagon faces interlaced with square faces, as shown in FIG. 5, and is geometrically described as a truncated octahedron. The major bond angles are those between two hexagons and those between a hexagon and a square, and are respectively 125 degrees 16 minutes and 109 degrees 16 minutes. In natural sodalite, the two relevant angles in degrees of the oxygen-silicon-oxygen bonds are 113.8 and 107.4 and for the oxygen-aluminum-oxygen bonds are 112.1 and 108.2.

The truncated octahedron is considered one of the 13 Archimedean solids, as shown in FIG. 6. These solids all have faces of two or more types of regular polygons. The truncated tetrahedron shows the “progression” from a tetrahedron to another tetrahedron since the tetrahedron is a duel to itself. For example connecting the midpoint of the faces yields another tetrahedron pointing in the opposite direction from the original. The center row of FIG. 6 shows the progression from a hexahedron to an octahedron. The bottom row of FIG. 6 shows the progression from a dodecahedron of two icosahedrons as corners are trimmed off and turned into other regular polygons. These solid geometrical shapes occur frequently in nature, and are themselves least energy configurations of their atomic constituents.

Consider the following geometrical model as shown in FIG. 7 for truncated octahedron. This geometrical model will be used to compute the actual number of atoms in the square and the hexagon for the experimentally derived optimal catalyst size. The equations of geometry for the truncated octahedron model are:
(1.73X)²=100+100−200 cos(θ₁) Eq. (1)
sin(θ₂)=X/20 Eq. (2)
θ₁+θ₂=π/2 (Eq. 3)
where X is the unknown length of the side, and the angles are defined within the figure, and the measurements are given in angstroms. For conversion, ten angstroms are equal to one nanometer. For the truncated octahedron, a band along the circumference would encompass 2 squares and 4 hexagons. Computed from geometry, the hexagon side-to-side length is 1.73 times the side length of the square. The above geometrical equations are then solved, yielding X equal to 6.67 angstroms. It is noted that the empirical nickel atomic radius is 1.35 angstroms and its Van de Waals radius is 1.63 angstroms. Thus, for a square with nickel atoms at the corners, one might consider a 3-atom by 3-atom square, 9 atoms total, corresponding to a range of X of 5.1 to 6.5 angstroms. The hexagon itself, with nickel atoms along the sides, would correspond to a side-to-side dimension of 11.5 angstroms, which would be 5 atoms between opposite sides. Thus the hexagon would theoretically have a total of 19 atoms, with an arranged row of 3-atoms, a row of 4-atoms, a row of 5-atoms, a row of 4-atoms, and a row of 3-atoms. As there is not a perfect atomic fit between all atoms in the faces, voids would be present.

The following references are included in this patent in their entirety and illustrate the partial state of knowledge of the field including the techniques described herein.

Adelung, R. et al.: “Nanowire Networks on Perfectly Flat Surfaces”, Applied Physics Letters, V. 74, No. 20 (1999), pp. 3053-3055.

Cao, G.: Nanostructures & Nanomaterials. London: Imperial College Press, 2004.

Doyle, A. et al.: “Hydrogenation on Metal Surfaces: Why are Nanoparticles More Active than Single Crystals?”, Angew. Chem, Int. Ed. (2003), 42, pp. 5240-5243.

Frey, W. et al.: “Ultraflat Nanosphere Lithography: A New Method to Fabricate Flat Nanostructures”, Adva. Mater. (2000), 12, No. 20, Oct. 16, pp. 1515-1519.

Grunes, J. et al.: “Catalysis and Nanoscience”, Chem. Comm. (2003), pp. 2257-2260.

Poole, C. and Owens, F.: Introduction to Nanotechnology. New York: John Wiley & Sons, Inc. 2003.

Schlogl, R. and Hamid, S.: “Nanocatalysis: Mature Science Revisited or Something Really New?”, Angew. Chem, Int. Ed. (2004), 43 pp. 1628-1637.

Seshan, K: Handbook of Thin-Film Deposition Processes and Techniques: Principles, Methods, Equipment and Applications, 2^{nd} Ed., Norwich, N.Y., 2002.

### SUMMARY

Demanding chemical reactions typically require a catalyst of three-dimensional form rather than a flat surface. For ethane hydrogenolysis, one example, reaction rates increase by a factor of 20 by inserting into the reactants a 20-angstrom diameter micro-particle of surface nickel over a truncated octahedron base. Advanced nanotechnological processing techniques with ultrahigh cooling rates such as chill block melting will produce a locally atomically flat substrate. Placing this substrate in compressive stress and then depositing a catalytically active metal or its oxide such as nickel or platinum on the substrate in a conventional atomic layer deposition system will create nano surface ripples. The ripple wavelength and slope in two dimensions can be optimized to mimic the geometry of the bulk catalyst particles. This modified rippled surface built up over the substrate will have the enhanced catalytic properties of the nano-sphere catalyst, but will be firmly attached to the substrate, a marked advantage over insertion of catalytic particles into the reactant flow stream. This new surface will also allow far more efficient catalytic conversion of reactants flowing over the surface than simply a flat metal catalytic surface. As an example, for an automobile catalytic converter whose flow stream comprises gases with hydrocarbons requiring demanding catalytic reactions, such a modified surface will allow construction of a converter that is substantially smaller and less expensive than now exists.

### BRIEF DESCRIPTION OF THE DRAWINGS

FIG. 1 illustrates the general nature of a catalyst;

FIG. 2 illustrates the electronic configuration of ethylene;

FIG. 3 illustrates the electronic configuration of ethane;

FIG. 4 illustrates a graph of nickel catalyst size versus activity;

FIG. 5 illustrates sodalite;

FIG. 6 illustrates the 13 Archimedean solids;

FIG. 7 illustrates a geometry model for truncated octahedron;

FIG. 8 illustrates a graph of structure, solidification and thermal gradient;

FIG. 9 illustrates a chill block melting apparatus;

FIG. 10 illustrates atomic growth mechanisms;

FIG. 11 illustrates an atomic layer deposition mechanical arrangement for titania film;

FIG. 12 illustrates the titania film atomic layer deposition;

FIG. 13 illustrates the atomic layer deposition operation for titania film;

FIG. 14 illustrates the compressive stress induced surface ripples;

FIG. 15 illustrates a view of a one-dimensional rippled surface with one axis stress;

FIG. 16 illustrates a view of a two-dimensional rippled surface with two equal axes stress;

FIG. 17 illustrates a view of a two-dimensional rippled surface with two unequal axes stress;

FIG. 18 illustrates a process to form a film on an atomically flat substrate; and

FIG. 19 illustrates the film layers on the atomically flat substrate.

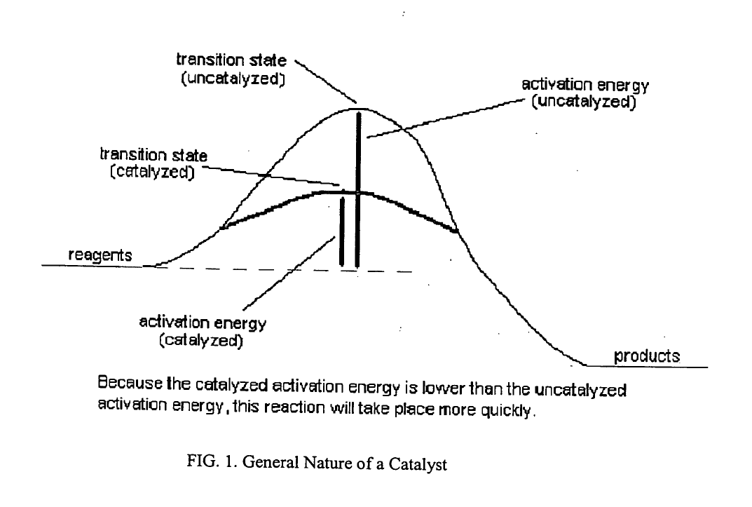

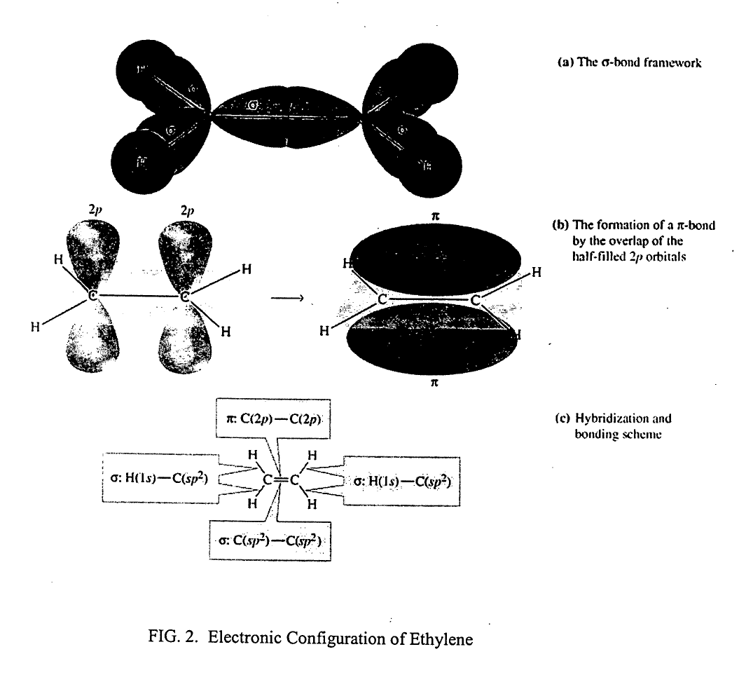

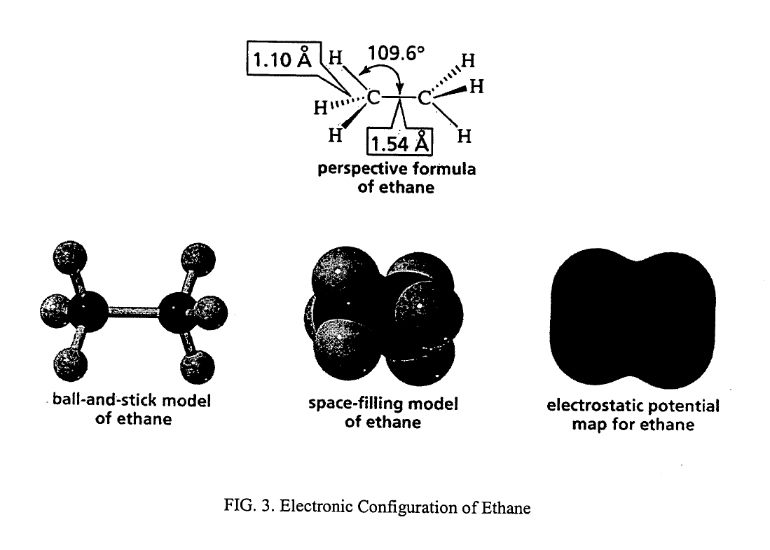

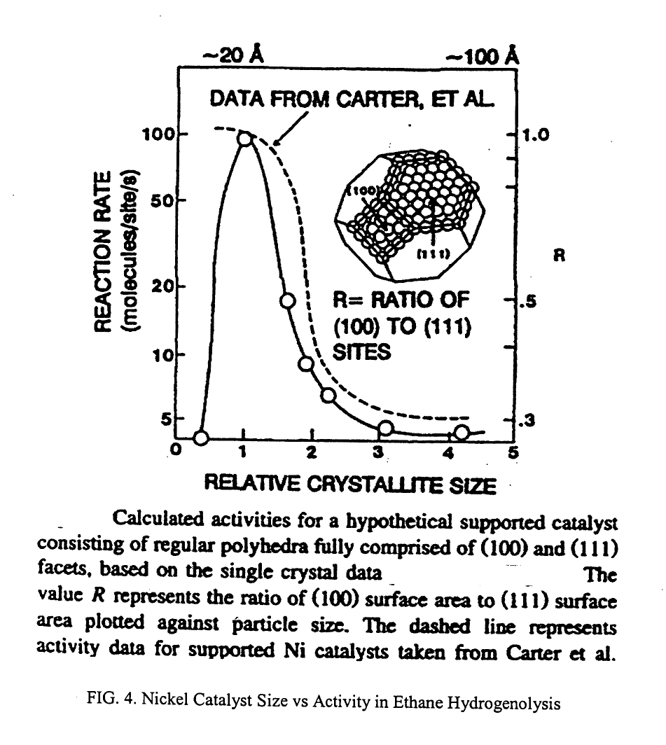

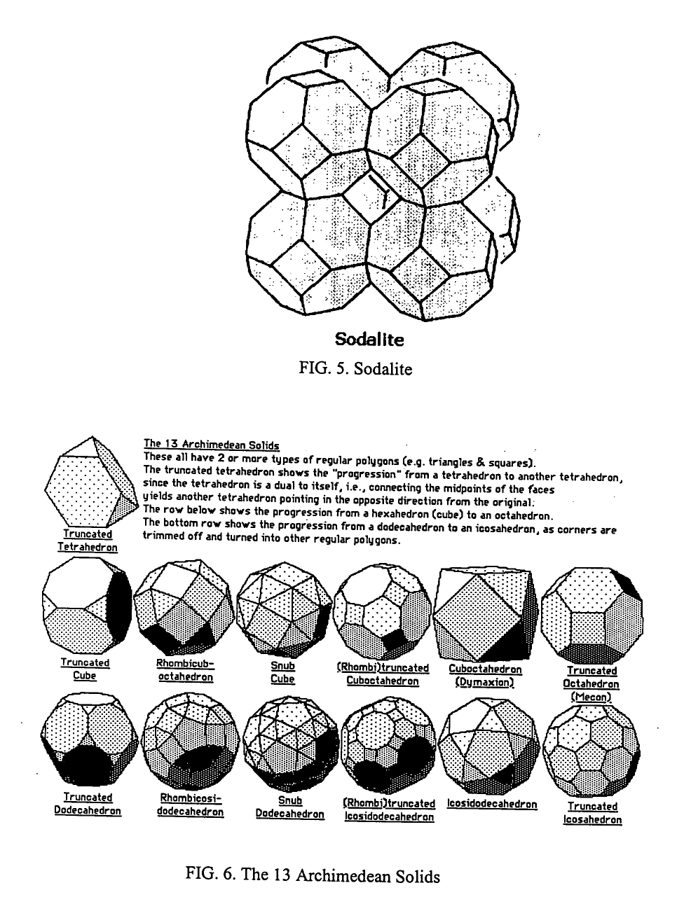

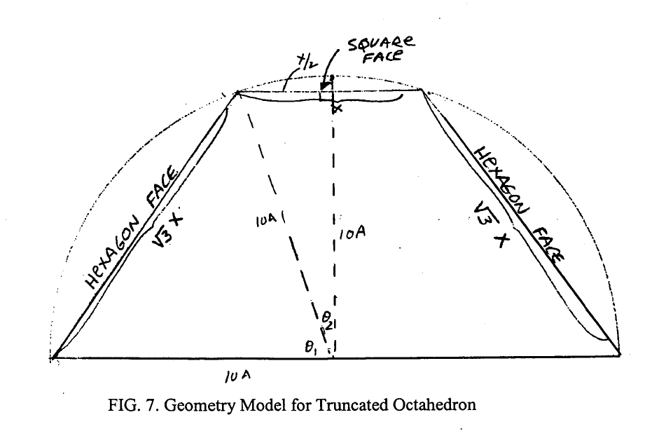

### DETAILED DESCRIPTION

### Creation of an Anatomically Flat Surface

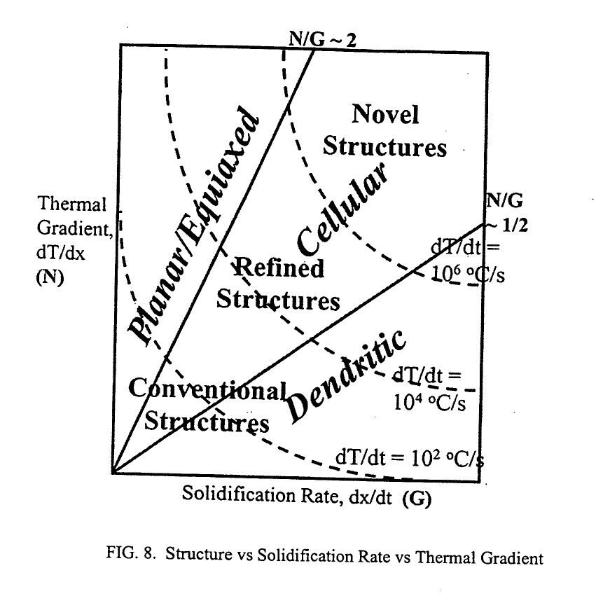

Generally, for the simulation of a single surface structure of 2 nanometers in linear dimension or wavelength, the surface should be flat to substantially within approximately 1 atom height of 0.2 nanometers for a length of 10 times the 2 nanometer dimension or 20 nanometers. A bulk nanostructured material is created for a substrate, reducing the number of dislocations present. The presence of dislocations would severely reduce the efficiency of a catalyst created for a demanding catalysis reaction. One method of creation of such a substrate would be by rapid solidification. Consider FIG. 8, which relates the resulting structure of a material versus the solidification rate and the thermal gradient. It is seen that novel material structures not commonly seen in nature arise for cooling rates exceeding 1 million degrees centigrade per second.

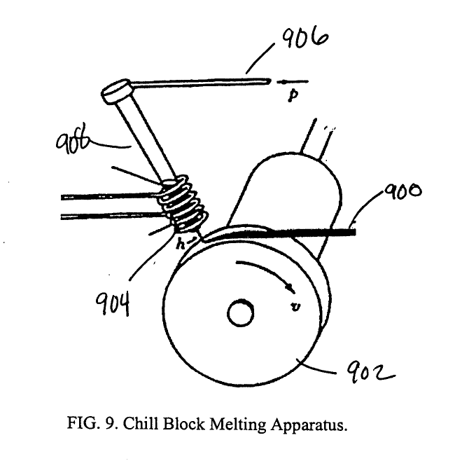

One method of rapid solidification in current commercial practice is chilled block melt spinning, in which a metal is melted to a liquid stream and then sprayed under pressure on a cooled rotating drum. A ribbon of the metal is produced, characterized by remarkably uniform thickness and virtual absence of crystalline defects. This method is illustrated in FIG. 9. In FIG. 9 a metal 906 enters a cylinder 908 to be melted. Cylinder 908 is heated by heating coils 904, and the metal is melted to a liquid stream. Cylinder 908 is under an external pressure and sprays the liquid stream onto drum 902. Drum 902 is rotated at a high rate of speed and cooled to produce a ribbon of metal 900, which is uniform and substantially free of crystalline defects. In general, there are various methods currently in use to create an atomically flat surface on a substrate.

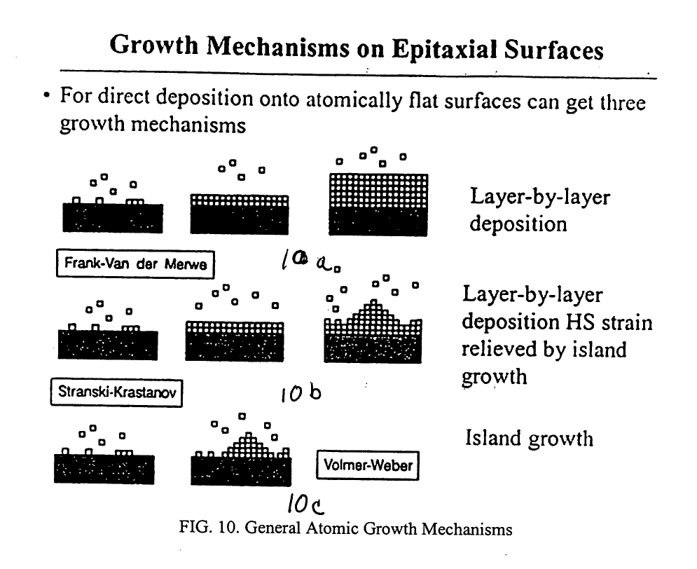

After the surface of the substrate is atomically flat, at least to the dimensions required for subsequent film geometry creation, then a thin film of a second material is applied to this substrate. In practice, for the nano dimensions considered, the film is grown on the substrate. Film growth methods are divided into two groups: vapor-phase deposition and liquid-based growth. Vapor-phase deposition techniques include evaporation, molecular beam epitaxy (MBE), chemical vapor deposition (CVD) and atomic layer deposition (ALD). Liquid-based growth techniques include electrochemical deposition, chemical solution deposition (CSD), Langmuir-Blodgett films and self-assembled monolayers (SAM). There are three general growth mechanisms shown in FIG. 10 on flat surfaces: layer-by-layer deposition shown in FIG. 10a, layer-by-layer deposition relieved by island growth shown in FIG. 10b, and island growth shown in FIG. 10c. The type of growth occurring will depend on the method of application of the film, and the exact nature of the film versus the substrate, including atomic bond length mismatch between the substrate and the film. Other types of film growth mechanisms are known by those skilled in the field. For the proposed structure the rate of deposition should be controlled and the film should be deposited one molecular layer at a time.

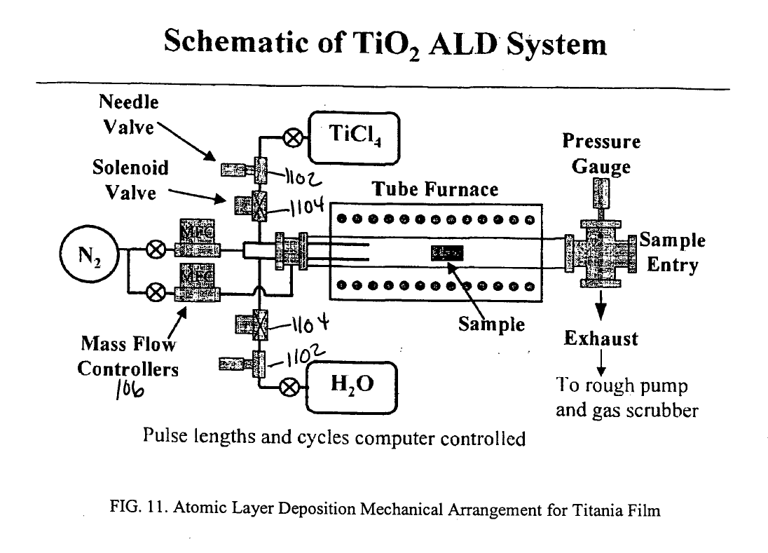

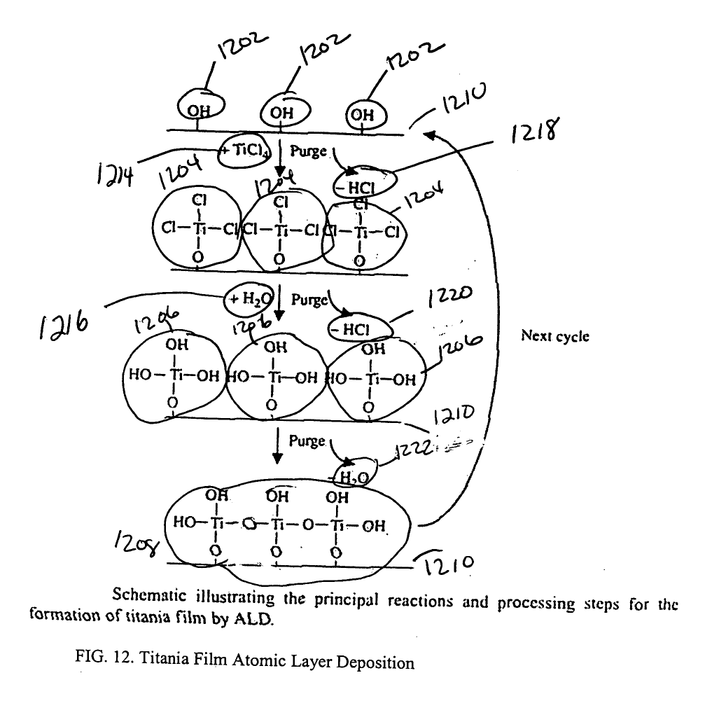

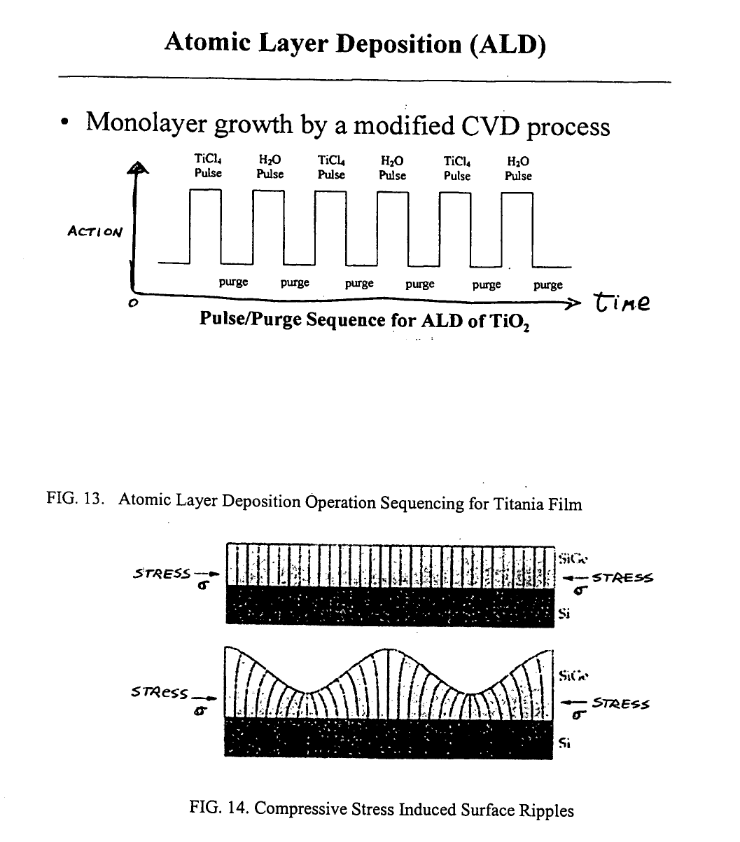

One preferred method currently in use to create controlled surface monolayers is atomic layer deposition. For illustration of this method, one may consider the monolayer deposition of titanium upon the substrate. A sequence of processing steps is used to substitute titanium upon the surface in a highly controlled manner. This technology is developed and presented for illustration that the technique of deposition of single layers of atoms is known in practice. The apparatus used for this process is shown in FIG. 11 and consists of a highly controlled heated enclosure with appropriate valves and reservoirs for injecting the required materials into this enclosure. The apparatus as shown in FIG. 11, and the method as shown in FIGS. 12 and 13, are optimized for the production of titania film, but the general method can be adapted to grow other films and structures.

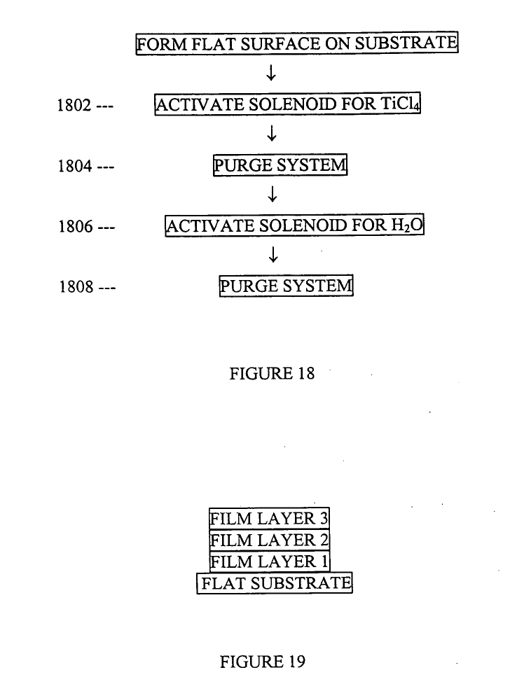

FIG. 11 shows that the amount of TiCl₄ and H₂O is controlled by needle valve 1102 and the duration of application is controlled by solenoid valve 1104. The mass controller 1106 controls the flow of N₂. FIGS. 13 and 18 shows the atomic layer deposition operation sequencing for titania film production. The first pulse during a first period of time controls the solenoid valve 1104 for TiCl₄. During this period of time TiCl₄ flows to the sample as shown in step 1802. Following this first period of time, the tube furnace is purged during a second period of time as shown in step 1804. During a third period of time, the solenoid valve 1104 for H₂O is controlled to allow H₂O to flow to the tube furnace as shown in step 1806. During a fourth period of time, a tube furnace is again purged as shown in step 1808. This process is repeated for each titania layer desired to be formed. FIG. 19 shows layer 1, layer 2 and layer 3 being formed as result of the sequence of steps shown in FIG. 13 and the apparatus in FIG. 11. FIG. 12 shows the principal reactions that occur to the surface 1210 of the sample during one cycle of deposition to form one layer. Initially, the surface 1210 includes OH molecules 1202 attached to the surface 1210. During the first period of time, TiCl₄ enters the tube furnace to be deposited on a surface 1210 of the sample. As shown in FIG. 12, the TiCl₄ 1214 reacts with the OH molecule 1202 to form TiCl₃O molecule 1204 on the surface 1210. During the second period of time, the tube furnace is purged to remove the HCl molecule 1218. During the third period of time, H₂O flows into the tube furnace. The H₂O reacts with the TiCl₃O molecule 1204 to form the TiOH₃O molecule 1206 on the surface 1210. During the fourth period of time, the tube furnace is purged of H₂O 1222. This allows a single atomic layer of titania film 1208 to form on the surface 1210.

The apparatus as shown in FIG. 11 may be adapted for the deposition of other metals and metallic oxides. For deposition of metals such as nickel, platinum or palladium on the substrate surface, substitute respectively nickel powder, platinum powder or palladium powder for the titanium oxide in the apparatus as shown in FIG. 11 and eliminate the step of water injection. For deposition of an oxide of a metal, such as nickel oxide, platinum oxide, or palladium oxide, substitute oxygen for water in the water chamber in the apparatus in FIG. 11, with the respective powdered metal in the titanium oxide reservoir. Alternatively, the metal oxide may be preformed and simply substituted for the titanium oxide in the apparatus as shown in FIG. 11 and eliminate the step of water injection. After the metal is deposited, the composite surface must be cleaned with an inert gas, such as nitrogen or argon, to eliminate excess metal atoms in the atomic layer deposition device as shown in FIG. 11. Subsequent layers of the film may then be deposited by repeating the process.

### Stress Induced Surface Variation

The first steps to create “ripples” in a nanometer scale on an atomically flat substrate surface is to place the substrate in compressive stress and then deposit 2 to 5 monolayers of a secondary component onto this substrate. The device to place the substrate into compressive stress will be located within the reaction chamber of the ALD device. This effect is shown in FIG. 14, for the case of a silicon-germanium film on a silicon substrate. Depending on the magnitude and nature of the stress, this added layer will compensate by developing ripples in its surface. Additional deposited depths of this secondary component will lead to point and line dislocations to relieve the stress. This will limit the depth of deposition so as not to have these types of material defects.

From a practical standpoint, one is concerned with creation of an atomically flat surface on a length scale that is at least 10 times larger than the wavelength of the spatially oscillating surface one is proposing to construct. Thus, for a variation between 2 to 5 monolayers of an atomic species with bond length of 2 angstroms, and a design wavelength of 2 nanometers, a flat surface is required for a distance of 20 nanometers, allowing end effects generated due to surface height variations to vanish within 3 wavelengths on each side of the end effect, leaving a minimum of at least 4 wavelengths of surface of the correct geometry.

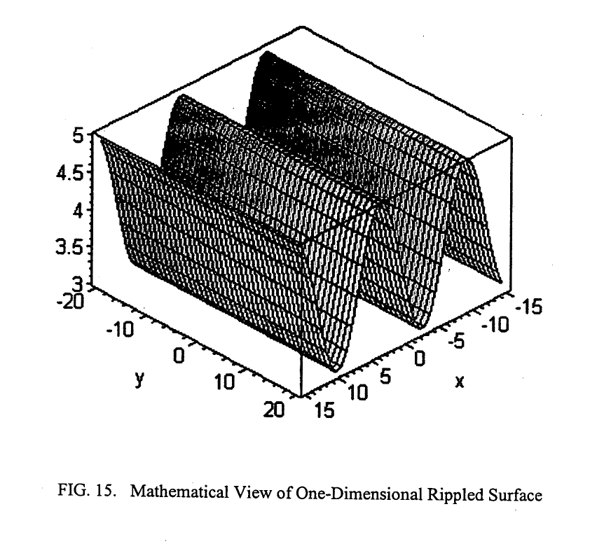

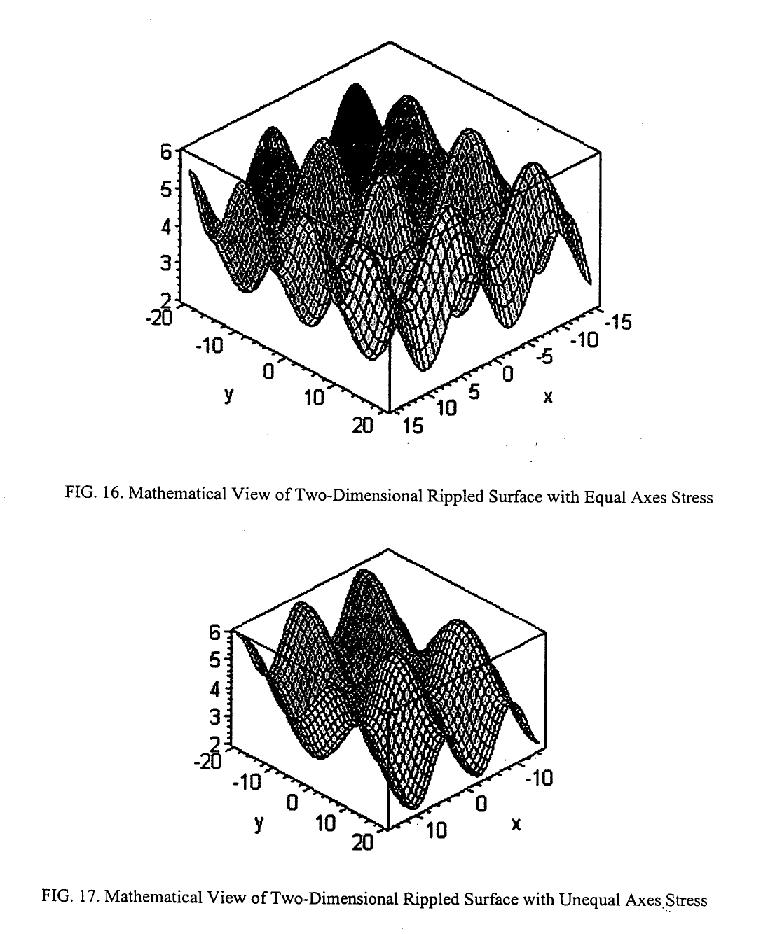

An example of a rippled surface is shown in FIG. 15, whereby the compressive stress is applied uniformly across the y-axis, at the x-axis endpoints. The peaks of the rippled surface and the troughs of the rippled surface are generally parallel and are generally of the same magnitude. Compressive stress may be applied in two planes as well, and if such stress is equally applied across the x and y axes, would yield a surface as shown in FIG. 16. The peaks and troughs of the rippled surface occur in a periodic fashion. If such compressive stress is unequally or non-linearly applied across the x and y axes, the compressive stress would yield a surface as shown in FIG. 17 with the peaks and troughs of the rippled surface occurring in a non periodic fashion. It can be seen that the geometry of the rippled surface can be manipulated by application of compressive stress in various manners.

In the engineering design of the rippled surface, one must consider the “roughness” of the surface film since the film is built up of individual atoms. When the dimensions of the atomic bond length are comparable to the curvature of the ripple, then smoothness of the curve is lost. The upper peak will not look like a sine wave, but rather will have a flat top or be composed of a single atom. Adjacent portions of the surface will have a net curvature. Clearly, the maximum curvature will occur at the peak of the ripple. Mathematically, the curvature is equal to the first derivative of the equation describing the ripple. Consider the following mathematical description (as referenced in FIGS. 15, 16 and 17), with x, y, and z as Cartesian coordinates, and A, B, and K are constants of design:
z=A+B* sin(K*x) Eq. (4)
dz/dx=B* K* cos(K*x) Eq. (5)
If d²z/dx²=−B* K²*sin(K*x)=0, then x=0, π/K, 2π/K, etc. Eq. (6)
then this surface curvature will reach a maximum when the second derivative of “z,” as in Eq (4) is set to zero. Thus, one may engineer a system to produce the angular curvature desired; that curvature will match the experimental catalytic angle obtained for the best reaction rate from the optimally sized catalyst.

### Composition of Monolayers upon the Substrate

The composition of the rippled layer placed upon the substrate may be either a single elemental metal or a metal-oxide. For a single metal, one may utilize a similar ALD arrangement, whereby the system is placed in a vacuum, and the metal is vaporized and allowed to settle on the substrate that has been placed in compressive stress in either one or two dimensions, stressed symmetrically or non-symmetrically. For a metal-oxide, a low concentration of oxygen is allowed into the fabrication oven, so that when the metal is vaporized, it combines with the oxygen prior to depositing on the substrate. By placement of the substrate physically above the emitted metal and gas, one may minimize deposition of foreign particles due to gravity and thus keep the surface cleaner.

Thus, it is seen that the above general method can be utilized to create a nano-engineered catalytic surface whereby the active geometry of known catalytic nano-spheres is retained, yet the surface is rigidly fixed to the substrate, allowing placement of the final composite to an outer metal housing. This fixed catalyst, optimized for surface geometry, will allow large increases in the catalytic rate for certain demanding reactions, and, in the one example previously given, represent a large improvement in the efficiency of the automobile catalytic converter. For an automobile catalytic converter whose flow stream comprises gases with hydrocarbons requiring demanding catalytic reactions, such a modified surface will allow construction of a converter that is substantially smaller and less expensive than now exists. Thus, for the same exhaust throughput, one may radically reduce the size of the automobile catalytic converter outfitted with this type of internal catalytic surface, and also substantially reduce the quantity of precious metal needed per converter. However, this technique is not confined to this particular application but is a general technique for enhancing the efficiency of demanding catalytic reactions utilizing fixed catalytic surfaces.

The present invention includes a general method of creating a three-dimensional catalytic surface by the placement of atomic model layers on a substrate that has been placed in compressive stress and is in an atomic growth chamber. The stress may be induced either directly mechanically or by using a substrate and a film layer with differing coefficients of thermal expansion. Stress is relieved in the thin layer with the creation of hills or arrays whose geometry can be controlled to essentially duplicate the net curvature of known metallic and metal oxide catalysts in demanding chemical reactions. There is a significant advantage in cost and operation by using such a prepared surface for catalytic reactions as opposed to placing micro particles in reaction chambers in bulk. This significant advantage is due to the bound nature of the catalyst, particularly for gas and vapor reactions flowing over the surface.

1) A method for forming a catalytic surface, comprising the steps of:
creating an atomically flat surface on a substrate;
stressing a film on said atomically flat surface;
forming at least one ripple in said film,
whereas at least one dimension of said ripple is less than 100 nanometers.

2) A method for forming a catalytic surface as in claim 1 wherein said step of stressing includes the step of compressively stressing said film along one axis parallel to the plane of said atomically flat surface.

3) A method for forming a catalytic surface as in claim 1 wherein said its step of stressing includes the step of compressively stressing said film along two axes parallel to the plane of said atomically flat surface.

4) A method for forming a catalytic surface as in claim 1 wherein said film is a catalytically active metal including nickel, platinum, and palladium.

5) A method for forming a catalytic surface as in claim 1 wherein said film is a titania film.

6) A method for forming a catalytic surface as in claim 1 wherein said film is the oxide of a catalytically active metal including nickel, platinum, and palladium.

7) A method for forming a catalytic surface as in claim 1 wherein said method further includes the step of using said rippled film in a catalytic converter.

8) A catalytic surface, comprising:
a substrate with an atomically flat surface;
a film formed on said atomically flat surface;
at least one ripple in said film,
whereas at least one dimension of said ripple is less than 100 nanometers.

9) A catalytic surface as in claim 8 wherein said film is compressively stressed along one axis parallel to the plane of said atomically flat surface.

10) A catalytic surface as in claim 8 wherein said film is compressively stressed along two axes parallel to the plane of said atomically flat surface.

11) A catalytic surface as in claim 8 wherein said film is a catalytically active metal including nickel, platinum, and palladium.

12) A catalytic surface as in claim 8 wherein said film is a titania film.

13) A catalytic surface as in claim 8 wherein said film is the oxide of a catalytically active metal including nickel, platinum, and palladium.

14) A catalytic surface as in claim 8 wherein said rippled film is in a catalytic converter.

15) A system using a catalytic surface, comprising:
a substrate with an atomically flat surface;
a film formed on said atomically flat surface;
at least one ripple in said film,
whereas at least one dimension of said ripple is less than 100 nanometers.

16) A system using a catalytic surface as in claim 15 wherein said film is compressively stressed along one axis parallel to the plane of said atomically flat surface.

17) A system using a catalytic surface as in claim 15 wherein said film is compressively stressed along two axes parallel to the plane of said atomically flat surface.

18) A system using a catalytic surface as in claim 15 wherein said film is catalytically active metal including nickel, platinum, and palladium.

19) A system using a catalytic surface as in claim 15 wherein said film is a titania film.

20) A system using a catalytic surface as in claim 15 wherein said film is the oxide of a catalytically active metal including nickel, platinum, and palladium.

21) A system using a catalytic surface as in claim 15 wherein said rippled film is in a catalytic converter.
